(19) United States
(12) Patent Application Publication
(10) Pub. No.: US 2025/0060002 A1
(43) Pub. Date: Feb. 20, 2025

(54) BEARING FOR MOUNTING THE DRIVE SHAFT OF A WORK APPARATUS IN A GUIDE TUBE, AND WORK APPARATUS INCLUDING THE BEARING

(71) Applicant: Andreas Stihl AG & Co. KG, Waiblingen (DE)

(72) Inventors: Simon Jetter, Urbach (DE); Lars Robert Kraft, Ludwigsburg (DE); Tobias Bernhard, Ilsfeld-Auenstein (DE); Matthias Maier, Waiblingen (DE)

(21) Appl. No.: 18/807,469

(22) Filed: Aug. 16, 2024

(30) Foreign Application Priority Data
Aug. 17, 2023 (DE) 10 2023 122 088.8

(51) Int. Cl. F16C 17/02; A01D 34/68; A01D 101/00

(52) U.S. Cl. CPC F16C 17/02; A01D 34/6806; A01D 2101/00; F16C 2310/00

(57) ABSTRACT

A bearing is provided for mounting the drive shaft of a work apparatus in a guide tube. The bearing includes a bearing tube defining a central axis and having a continuous bearing opening for receiving the drive shaft. The bearing opening is non-circular in at least one cross section. In the non-circular cross section, the bearing opening has first sections lying against an incircle of the bearing opening and second sections lying in the circumferential direction between the first sections. The second sections are at a distance from the incircle. The first sections are in the form of elevations whereat the inner wall of the bearing opening projects in the direction of the central axis. A work apparatus includes the bearing.

### CROSS-REFERENCE TO RELATED APPLICATIONS

This application claims priority of German patent application no. 10 2023 122 088.8, filed Aug. 17, 2023, the entire content of which is incorporated herein by reference.

### TECHNICAL FIELD

The disclosure relates to a bearing for mounting the drive shaft of a work apparatus in a guide tube, and to a work apparatus with a bearing.

### BACKGROUND

EP 1 747 381 B1 discloses a bearing for the drive shaft of a work apparatus in a guide tube. The bearing includes a bearing sleeve and flanges extending outward. The material of the flange and the material of the sleeve are intended to have properties such that radial forces which act on the flanges and are directed toward the central axis of the sleeve can be converted into elastic deflections of the sleeve.

### SUMMARY

It is an object of the disclosure to provide a bearing of the type in question with improved properties.

This object is achieved with respect to the bearing by a bearing for mounting a drive shaft of a work apparatus in a guide tube. The bearing defines a central axis and includes: a bearing tube having a continuous bearing opening for receiving the drive shaft of the work apparatus; the bearing opening defining an incircle and an inner wall and having at least one cross section whereat the bearing opening has a non-circular cross section; in the non-circular cross section, the bearing opening having first sections lying against the incircle of the bearing opening and having second sections lying in a circumferential direction between the first sections; the second sections lying at a distance (a) from the incircle; and, the first sections of the bearing opening being in a form of respective elevations whereat the inner wall of the bearing opening projects in a direction of the central axis.

It is a further object of the disclosure to provide a work apparatus with improved properties.

This object is achieved by a work apparatus including: a housing; a drive motor having an output shaft and being arranged in the housing; a tool head having a tool; a guide tube extending between the housing and the tool head; a bearing arranged in the guide tube; a drive shaft extending through the bearing and being configured to provide an operative connection between the output shaft of the drive motor and the tool of the tool head; a bearing mounting the drive shaft in a guide tube. The bearing defines a central axis and includes: a bearing tube having a continuous bearing opening for receiving the drive shaft of the work apparatus; the bearing opening defining an incircle and an inner wall and having at least one cross section whereat the bearing opening has a non-circular cross section; in the non-circular cross section, the bearing opening having first sections lying against the incircle of the bearing opening and having second sections lying in a circumferential direction between the first sections; the second sections lying at a distance (a) from the incircle; and, the first sections of the bearing opening being in a form of respective elevations whereat the inner wall of the bearing opening projects in a direction of the central axis.

It has been shown that, during operation, vibrations of the drive shaft in the bearing may occur, which may lead to the drive shaft striking in the bearing opening. These movements may be transmitted to the guide tube, resulting in unpleasant noise and increased vibration.

It has now been shown that the drive shaft vibrations can be reduced by reducing the play between the drive shaft and the bearing opening. In order to keep a possible movement of the drive shaft in the bearing transversely with respect to the central axis of the bearing to a minimum, it is provided according to the disclosure that the bearing opening has a non-circular cross section, wherein, in the non-circular cross section, first sections lie against an incircle of the bearing opening and second sections lie between the first sections, which second sections are at a distance from the incircle at each point. It is provided that the first sections of the bearing opening are in the form of elevations which project from the inner wall of the bearing opening in the direction of the central axis.

The elevations protruding toward the central axis enable good guidance for the drive shaft to be achieved. The tolerances of the drive shaft and bearing can be coordinated with one another in such a way that there is little or no play between drive shaft and bearing, depending on the tolerance position. Owing to the second sections, which are at a distance from the incircle of the bearing opening, the bearing opening does not lie over its entire circumference, but only partially against the drive shaft. The first sections make it possible in a simple way to minimize the tolerances between the bearing and the drive shaft. The effect of the tight guidance of the drive shaft in the bearing tube is in particular that the drive shaft, together with the bearing, oscillates as a rigid body against the guide tube, thereby creating a vibration system with a lower natural frequency.

The non-circular cross section of the bearing opening is a cross section that differs from the circular shape. For example, the cross section may be in the form of a polygon or have round and/or rectilinear sections.

The incircle is understood here as meaning the largest circle which can be inscribed in the bearing opening and which only touches the bearing opening tangentially. The incircle does not intersect the bearing opening. In particular, the incircle touches the bearing opening at least at three points.

The fact that the first sections are spaced apart from one another in the circumferential direction can reduce the friction between bearing and drive shaft, since exacting tolerances can be produced.

The first sections may be arranged at the bearing opening in particular symmetrically, for example mirror symmetrically or point symmetrically to the central axis. The same or different angular distances between adjacent first sections may be provided here.

The first sections are arranged continuously, in particular in the longitudinal direction of a bearing. Alternatively, a plurality of first sections may be provided in the longitudinal direction of the bearing, between which regions without first or second sections extend. In the regions without first sections and/or without second sections, it may be provided that the bearing opening does not lie against the drive shaft.

In particular, the bearing tube has an approximately constant wall thickness. The bearing tube denotes the central, in particular substantially cylindrical, section of the bearing which has the bearing opening. In particular, the maximum wall thickness of the bearing tube is not more than 150%, in particular not more than 120%, in particular not more than 110% of the minimum wall thickness of the bearing tube. In particular, lubricant, in particular grease, is disposed between the second sections and the drive shaft. In particular, the number of first sections is greater than three, in particular greater than five. In particular, a plurality of first sections of the bearing tube each lie opposite one another, in particular diametrically opposite, in a cross section.

Advantageously, the first sections of the bearing opening are at least partially convex. This results in a comparatively high rigidity of the first sections in the direction of the central axis. In particular, deflection of the first sections radially outward can thereby be avoided. The configuration of the first sections as elevations, in particular at least partially convexly, makes it possible in a simple way to implement contact with a drive shaft at discrete, defined small regions, in particular in the cross section. A radius of curvature of convexly configured first sections is smaller, in particular not more than half as large, in particular not more than one third as large as the radius of the incircle. The second sections in particular have a maximum radius of curvature greater than the radius of curvature of convexly configured first sections.

In particular, the second sections of the bearing opening adjoin the first sections in the circumferential direction. The entire bearing opening is delimited—with respect to a cross section—in particular exclusively by first sections and second sections. In particular, further sections are not provided. In an alternative version, apart from the first sections and the second sections, further sections of the bearing opening may be provided.

The first sections include in particular all of the regions of the bearing opening that are at a distance of less than 0.1 mm from the incircle. The first sections may accordingly have regions that are at a small distance from the incircle. The distance is measured radially outward from the incircle.

The first sections extend in particular in each case over an angle of extent of 1° to 20°, very particularly in each case over an angle of extent of 5° to 15° about the central axis.

The sum of the angles of extent of all of the first sections is in particular less than 160°, in particular less than 120°, very particularly not more than 90° about the central axis.

In particular, the second sections of the bearing opening are at a distance from the incircle of less than 2.0 mm at each point. The second sections of the bearing opening are accordingly also arranged comparatively close to the incircle. This achieves a comparatively high stability of the bearing opening. Owing to the tight contact and guiding of the drive shaft at the elevated first sections, lubricant can be stripped off in and carried along out of the cavity between drive shaft and second sections as required during operation. The removal of the lubricant from the cavity is facilitated by the relatively small radial distance between second section and drive shaft.

In particular, the bearing opening has more than three, in particular more than five, first sections. A greater number of first sections and consequently also second sections results in a larger number of cavities and thus in a more uniform distribution of the lubricant over the circumference of the drive shaft. This results in smoother running of the drive shaft in the bearing tube.

In particular, the bearing has at least one support element, which extends outward from the bearing tube relative to the central axis. In particular, the support element has at least one elastic means, which extends at least over a part of the radial extent of the support element. In particular, the support element is elastic.

In particular, all of the support elements each have an elastic means.

To support the bearing tube, for example in a guide tube of a work apparatus, support elements extend in particular from the bearing tube outward, that is, away from the central axis in the direction of the guide tube, in particular outward from the bearing tube radially with respect to the central axis. The support elements support the bearing tube in the guide tube. The support elements bridge the distance between bearing tube and guide tube. The origin of the support element lies in particular opposite in a second section of the inner wall. In other words: the support element is in particular attached at a point of the bearing tube at which the inner wall of the bearing is at a distance from the drive shaft.

In particular, the bearing has at least two support elements. The support elements are used in particular to support the bearing tube inside the guide tube. In particular, at least two first sections, in particular at least three first sections, are arranged between support elements which are adjacent in the circumferential direction with respect to the central axis. With respect to the same cross section, the drive shaft is supported in particular at a greater number of points in the bearing tube than the bearing tube is supported in the guide tube. The support elements are configured in particular as support ribs. The interaction of tight support of the drive shaft in the bearing tube and less tight and/or elastic support of the bearing or bearings in the guide tube leads to a particularly effective decoupling of the drive shaft vibrations from the guide tube.

In particular, the bearing has at least one stiffening element. For example, the stiffening element may surround the bearing tube. Alternatively, the stiffening element may protrude outward as a stiffening rib from the bearing tube relative to the central axis. Other configurations of a stiffening element may also be advantageous. The stiffening element may have a different wall thickness and/or be made from a different material than the bearing tube. The stiffening element makes it possible to ensure that the bearing is not excessively deformed when the drive shaft moves in the bearing, thus preventing vibrations of the drive shaft.

It may be provided that, in addition to the support elements, at least one stiffening element, in particular stiffening ribs, is/are provided. The at least one stiffening element is arranged in particular outside the bearing tube and serves to increase the moment of resistance of the bearing tube to bending. In particular in the case of bearing tubes with an outer diameter of less than or equal to 20 mm, stiffening elements are advantageous.

The at least one stiffening element is arranged in particular in the circumferential direction about the central axis between two support elements. The stiffening element extends outward in particular radially starting from the bearing tube and/or connects support elements which are adjacent about the central axis in the circumferential direction.

The at least one stiffening element, in particular the at least one stiffening rib, is arranged in particular between adjacent support elements. In particular, a plurality of stiffening ribs are arranged between adjacent support elements. The stiffening elements, in particular stiffening ribs, are arranged in particular between an outer wall of the bearing tube and an inner wall of a guide tube of a work apparatus, wherein they are spaced apart from the inner wall of the guide tube. The increase in the moment of resistance of the bearing tube to bending is advantageous in order to avoid the bearing tube from locally following the vibration of a drive shaft of the work apparatus.

In particular, at least one stiffening element, in particular all of the stiffening elements, is/are at a smaller maximum radial distance from the central axis than the at least one support element. The arrangement is made in particular in such a way that, when the bearing is arranged in a guide tube of a work apparatus, the support elements are in contact with the guide tube and the stiffening elements are at a distance from the guide tube.

Alternatively or in addition to the measures described, the inner wall of the bearing tube and/or the inner wall of the guide tube and/or the support element may be provided with elastic means or have elastic means, in particular a coating and/or a section made from a lower strength material. In this way, the vibration of the drive shaft in the bearing tube and/or the vibration of the bearing tube in the guide tube can be dampened.

Advantageously, the bearing has at least three support elements, in particular at least four support elements.

In particular, at least one elastic means is composed of a different material than the bearing tube. The material for the at least one elastic means may be, for example, rubber or a foamed polyurethane, for example Cellasto (registered trademark of BASF Polyurethans GmbH).

In particular, the bearing is at least partially formed from plastic. It may be provided that the bearing is formed entirely from plastic. The bearing may, for example, be at least partially, in particular completely made from polyamide and/or from thermoplastic elastomer. A configuration composed of at least two materials may be provided. Alternatively, it may be provided that the bearing is formed from a single material.

In particular, the bearing is composed at least partially, in particular completely, of polyamide, for example PA6 or PA66. The bearing may include fiber-reinforced material, in particular glass-fiber-reinforced material, in particular fiber-reinforced polyamide.

Advantageously, the bearing has a length measured in the direction of the central axis of at least 1 cm, in particular of at least 2 cm, in particular of at least 3 cm. In particular, this ensures that the bearing in the guide tube is sufficiently stable against tilting.

A work apparatus includes a housing in which a drive motor is arranged, a tool head, and a guide tube extending between the housing and the tool head. A bearing, through which a drive shaft of the work apparatus extends, is arranged in the guide tube. The drive shaft is arranged in operative connection between an output shaft of the drive motor and a tool of the tool head.

In particular, a plurality of bearings are provided in the guide tube. In particular, the sum of the lengths of the bearings arranged in the guide tube is at least 5% of the length of the guide tube. Further bearings of the drive shaft may be arranged outside the guide tube.

In particular, the bearing or at least one of the bearings extends over at least 50%, in particular over at least 70% of the length of the guide tube. It may be provided here that the drive shaft is supported by precisely one bearing. Alternatively, additional bearings may be provided to support the drive shaft. In particular, the length of the further bearings of the drive shaft is shorter. Alternatively or additionally, it may be provided that one or more further bearings are arranged in a housing of the work apparatus.

In particular, a first bearing is at a first distance from an adjacent, second bearing, and the second bearing is at a second distance from an adjacent third bearing. In particular, the first distance is at least 110% of the second distance. The fact that the first and the second distance differ in size makes it possible in a simple way to prevent the drive shaft from vibrating naturally.

In particular, a bearing is not arranged on an anti-node of vibration or on a vibration node of the natural vibration form of the guide tube. This is particularly advantageous if a plurality of bearings are provided, the length of which is less than 50% of the length, in particular less than 30% of the length of the guide tube. In particular, a bearing is not arranged on an anti-node of vibration or on a vibration node of the natural vibration form of the assembly consisting of guide tube, drive shaft and the at least one bearing. It has been shown that the arrangement of the bearings outside anti-nodes of vibration and vibration nodes of the natural vibration form of drive shaft or guide tube, drive shaft and the at least one bearing can achieve a good mounting with a low tendency of the system to vibrate.

### BRIEF DESCRIPTION OF DRAWINGS

The invention will now be described with reference to the drawings wherein:

FIG. 1 shows a schematic illustration of a work apparatus;

FIG. 2 and FIG. 3 show schematic illustrations of embodiments of the guide tube of the work apparatus from FIG. 1;

FIG. 4 shows a schematic sectional illustration through an embodiment of a bearing;

FIG. 5 shows a partial enlarged illustration of the bearing from FIG. 4;

FIGS. 6 and 7 show schematic illustrations of bearings with stiffening elements; and,

FIG. 8 and FIG. 9 show schematic sectional illustrations of further embodiments of a bearing in cross section.

### DETAILED DESCRIPTION

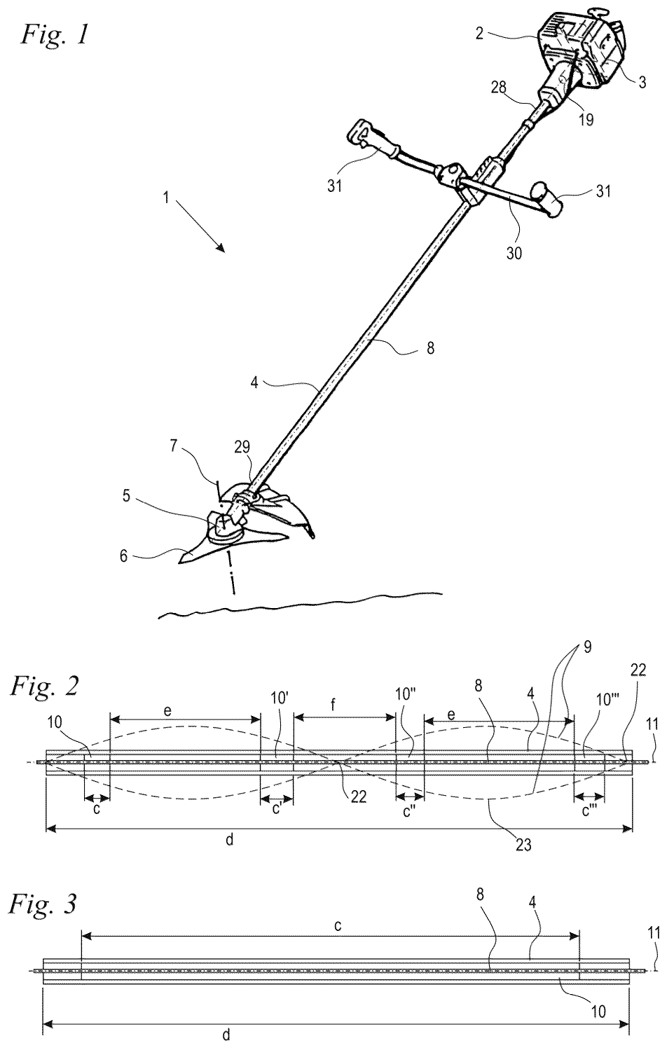

FIG. 1 schematically shows a work apparatus 1. The work apparatus 1 is what is referred to as a work apparatus with a long shaft. In the embodiment, the work apparatus 1 is a brushcutter. The work apparatus 1 includes a guide tube 4. A housing 2 is arranged at a first end 28 of the guide tube 4. A tool head 5 which carries a tool 6 is arranged at a second end 29 of the guide tube 4. A drive motor 3 is arranged in the housing 2. The drive motor 3 may be an internal combustion engine or an electric motor, in particular an electric motor driven by a battery. The drive motor 3 is used to drive the tool 6. In the embodiment, the tool 6 is a blade which is rotationally driven about a rotational axis 7. In an alternative configuration, for example in a configuration of the work apparatus 1 as a pole pruner, the tool 6 may be, for example, a saw chain. The tool 6 may also be a cutting string of a string mower head. Other tools 6 can also be advantageous.

In the embodiment, a handle unit 30 is held on the guide tube 4. In the embodiment, the handle unit 30 includes two handles 31. Other configurations of the handle unit 30 and a different number of handles 31 may also be advantageous. In addition to the handle unit 30, a further handle may be provided, the handle portion of which surrounds the guide tube 4.

The drive motor 3 has an output shaft 19, which is rotationally driven during operation. The output shaft 19 can be coupled or is coupled to a drive shaft 8 during operation. The drive shaft 8 protrudes through the guide tube 4. The drive shaft 8 is operatively connected to the tool 6. The operative connections between output shaft 19 and drive shaft 8 and of drive shaft 8 and tool 6 may be suitably configured and include clutches, transmissions or the like.

As illustrated schematically in FIG. 2, the drive shaft 8 is rotatably mounted in the guide tube 4 via at least one bearing 10. In the embodiment according to FIG. 2, four bearings 10, 10′, 10″ and 10′ are provided. Another number of bearings 10 may also be advantageous. In addition to the at least one bearing 10 arranged in the guide tube 4, further bearings 10 or differently configured bearings can be provided in the housing 2 and/or in the tool head 5 and/or in other adjacent components. The bearing 10 has a length c. The length c is measured along a central axis 11 of the bearing 10. The central axis 11 coincides in particular with the rotational axis of the drive shaft 8. The bearing 10′ has a length c′. The bearing 10″ has a length c″. The bearing 10′″ has a length c″″. The lengths c, c′, c″ and c′″ may be identical in size. Different lengths c, c′ c″, c″ of the bearings 10, 10′, 10″, 10′ may also be advantageous.

A first distance e is formed between the bearing 10 and the bearing 10′. A second distance f is formed between the bearing 10′ and the bearing 10″. In the embodiment, it is provided that the distances e and f differ in size. In particular, the first distance e is at least 110% of the second distance f. A distance between the bearing 10″ and the bearing 10″ may, for example, correspond to the first distance e. Another distance between the bearing 10″ and the bearing 10′″ may also be advantageous. In particular, the distance between the bearing 10″ and the bearing 10′″ is at least 110% of the second distance f. Alternatively, the distance f may be at least 110% of the distance e.

The guide tube 4 has a length d measured in the direction of the central axis 11. The sum of the lengths c, c′, c″ and c″″ of the bearings 10, 10′, 10″, 10″ is in particular at least 5%, in particular at least 10% of the length d of the guide tube 4. The length c, c′, c″, c′″ is in particular at least 1 cm, in particular at least 2 cm, especially in particular at least 3 cm.

It has been shown that the drive shaft 8 in the guide tube 4 can vibrate during operation with a natural vibration form 9, which is schematically indicated in FIG. 2 by dashed lines. The magnitude of the vibration is illustrated in greatly enlarged form here. The natural vibration form 9 has vibration nodes 22 and anti-nodes of vibration 23. In the vibration nodes 22, the movement of the drive shaft 8 is minimal. In the anti-nodes of vibration 23, the movement of the drive shaft 8 is at maximum. In particular, the drive shaft does not move transversely with respect to the central axis 11 in the vibration nodes 22.

It has been shown that an advantageous arrangement of the bearings 10, 10′, 10″ and 10″ results when at least one bearing 10, 10′, 10″, 10″, in particular all of the bearings 10, 10′, 10″, 10′ are arranged outside the anti-node of vibration 23 and/or the vibration node 22 of the natural vibration form 9 of the guide tube 4. Advantageously, a bearing 10, 10′, 10″, 10′ is not arranged on an anti-node of vibration 23 and a bearing 10, 10′, 10″, 10′ is not arranged on a vibration node 22 of the natural vibration form 9 of the guide tube 4. As a result, the movement of the drive shaft 8 can be readily reduced. Owing to the arrangement outside anti-nodes of vibration 23, the load on the bearings 10, 10′, 10″, 10′ is minimized.

FIG. 3 shows an alternative configuration in which a bearing 10 is arranged in the guide tube 4. The bearing 10 has a length c. The length c is advantageously at least 50%, in particular at least 70% of the length d of the guide tube 4. It may be provided that the drive shaft 8 is mounted with precisely one bearing 10, as illustrated in FIG. 3. Alternatively, further bearings 10 may be provided in the guide tube 4 and/or in adjacent housing parts such as the housing 2 and/or the tool head 5 for the drive shaft 8. The further bearings advantageously have a shorter length c than the illustrated bearing 10.

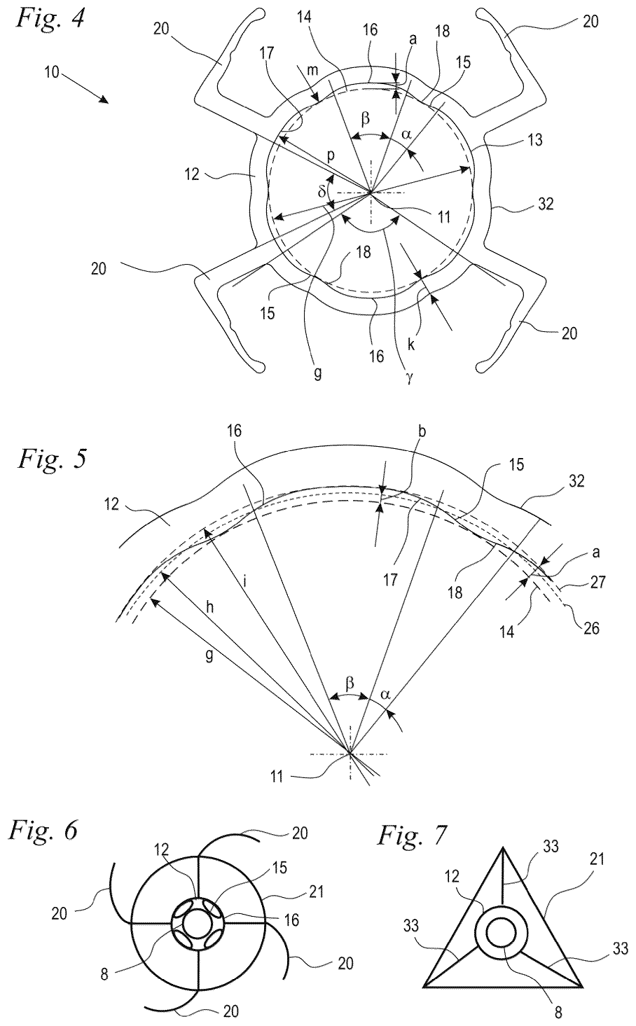

FIG. 4 shows an example of a section through a bearing 10. The bearing 10 has a bearing tube 12. The bearing tube 12 has a bearing opening 13, which is used to receive the drive shaft 8 of the work apparatus 1. In the embodiment, the cross-sectional shape of the bearing tube 12 is approximated to a circular shape. However, the bearing tube 12 has a non-circular cross section, that is, a cross section deviating from the circular shape. In the embodiment, the bearing tube 12 is formed both on its outside and on its inside with a cross section which deviates from the round shape. At least the inside of the bearing tube 12 deviates from the circular shape in cross section.

The bearing opening can have any contour that deviates from the circular shape, in particular any contour composed of rectilinear and/or curved sections. The bearing tube 12 has an outer wall 32. On the outer wall 32, the bearing tube 12 in the embodiment carries support elements 20, which serve to support an inner wall of the guide tube 4. In the embodiment, the support elements 20 are configured as outwardly projecting, angled arms or ribs. The support elements 20 are elastic in particular at least at their ends and resilient radially with respect to the central axis 11, and therefore secure contact of the support elements 20 on the inner circumference of the guide tube 4 can be ensured. The support elements 20 can extend in the axial direction over the entire length of the bearing 10. In particular, at least two, in particular at least three support elements 20 are provided. In the embodiment, two first sections 15 are arranged in a circumferential section between the connection of two adjacent support elements 20 to the bearing tube 12.

The bearing opening 13 has an incircle 14. The incircle is the largest circle which can be inscribed in the bearing opening 13. The incircle 14 lies in particular at least at three points of the bearing opening 13. The incircle 14 lies in particular tangentially to the bearing opening 13 and does not intersect the bearing tube 12. The incircle 14 has a diameter g. In the embodiment, the center point of the incircle 14 lies on the central axis 11. The center point of the incircle 14 lies in particular on the rotational axis of the drive shaft 8.

The bearing opening 13 includes first sections 15 lying against the incircle 14 and second sections 16 lying in the circumferential direction between the first sections 15. The second sections 16 are at a distance a from the incircle at each point. The size of the distance a may differ in size here at different points of the second sections 16. The first sections 15 may lie completely against the incircle 14 or have points which are at a distance from the incircle 14.

In the embodiment, the bearing opening 13 has six first sections 15. In particular, the bearing opening 13 has more than three, in particular more than five, first sections 15.

The bearing opening 13 is delimited by an inner wall 17 of the bearing opening 13. The first sections 15 of the bearing opening 13 are in the form of elevations 18 at which the inner wall 17 of the bearing opening 13 projects in the direction of the central axis 11. In the embodiment, the second sections 16 are arranged at a small distance from the incircle 14. The second sections 16 of the bearing opening 13 are at a distance a from the incircle 14, which in particular at any point of the second sections 16 is less than 2.0 mm. The origin of the support elements 20 lies in each case opposite a second section 16 of the inner wall 17. In the embodiment, the inner wall 17 is formed continuously by the mutually adjoining, alternately arranged first sections 15 and second sections 16. The inner wall 17 has in particular exclusively first sections 15 and second sections 16 in at least one cross section running perpendicularly to the central axis 11, in particular in all of the cross sections perpendicular to the central axis 11 through the bearing 10. In the embodiment, six first sections 15 and six second sections 16 are provided. In an advantageous alternative embodiment, an odd number of first sections 15 and an odd number of second sections 16 are provided. In particular, first sections 15 do not lie diametrically opposite relative to the central axis 11 in a cross section through the bearing 10. Between two support elements 20 which are adjacent in the circumferential direction relative to the central axis 11, two first sections 15 are arranged in at least one circumferential region y. The circumferential region y is measured here between the connecting points of the support elements 20 on the bearing tube 12. A first section 15 is arranged in another circumferential region 8 between two adjacent support elements 20. With respect to the same cross section, the number of points at which the drive shaft 8 is supported in the bearing tube 12 is greater than the number of points at which the bearing tube 12 is supported in the guide tube 4. In the embodiment, the drive shaft 8 is supported in the bearing tube 12 at six points, which are each arranged on a first section 15. The bearing tube 12 is supported in the guide tube 4 at four points, namely in each case with a support element 20.

As shown in FIG. 4, the first sections 15 in the embodiment extend in each case over an angle of extent α. The first sections 15 extend in particular in each case over an angle of extent α of 1° to 20°, in particular 5° to 15° about the central axis 11. The second sections 16 extend in each case over an angle of extent β. The first sections 15, in particular taken together, extend over an angle of less than 160°, in particular less than 120°, very particularly not more than 90° about the central axis 11.

A detail of the inner wall 17 is illustrated in enlarged form in FIG. 5. All of the regions of the inner wall 17 that lie between the incircle 14 and a circle 26 are considered to be first sections 15. The circle 26 has the same center point as the incircle 14 and a diameter h. A distance b between the circle 26 and the incircle 14 is less than 0.1 mm. All of the regions of the inner wall 17 that extend between the circle 26 and an outer circle 27 are considered to be second sections 16. The outer circle 27 is a circle in which the inner wall 17 is completely located and the center point of which coincides with the center point of the incircle 14. The outer circle 27 lies tangentially to the inner wall 17 and does not intersect the inner wall 17. The outer circle 27 has a diameter i. The distance a of the second sections 16 from the incircle 14 corresponds at maximum to the distance between the outer circle 27 and the incircle 14, that is, to half the difference of the diameters i and g.

In the embodiment, the angle of extent β of at least one second section 16 is greater than the angle of extent α of at least one first section 15. In the embodiment, all of the angles of extent β of the second sections 16 are equal. However, different angles of extent β of the second sections 16 may also be advantageous. In the embodiment, all of the angles of extent α of the first sections 15 are equal. Different angles of extent α of the first sections 15 may also be advantageous. In the embodiment, all of the angles of extent β taken in isolation are each greater than each individual one of the angles of extent α, in particular at least twice as large.

The first sections 15 of the bearing opening 13 are in particular at least partially convex. The first sections 15 are formed in particular by elongate, hill-shaped elevations of the inner wall 17.

The convex first sections 15 have a radius of curvature m. The second sections 16 have a maximum radius of curvature p. In the embodiment according to FIG. 4, the maximum radius of curvature p approximately corresponds to the maximum distance of the second sections 16 from the central axis 11. The radius of curvature m of the convex first sections 15 is smaller than, in particular not more than half as large as, in particular not more than one third as large as, the radius of the incircle 14. The radius of the incircle 14 corresponds to half the diameter g of the incircle 14. The maximum radius of curvature p of the second sections 16 is in particular greater than the radius of curvature m of the convex first sections 15.

It can be provided that the bearing 10 has the contour of the inner wall 17 over its entire length, as illustrated in FIG. 4 and FIG. 5. However, it may also be advantageous that the inner wall 17 of a bearing 10 has regions without first sections 15 and/or without second sections 16. In particular, the inner wall 17 has longitudinal sections in which the drive shaft 8 does not lie against the inner wall 17 and which are at a distance from the incircle 14 at each point of the cross section.

The bearing 10 is in particular at least partially formed from plastic. In the embodiment according to FIG. 4, the bearing 10 is formed from a single material. A configuration consisting of a plurality of different components may alternatively also be provided. In the embodiment, the bearing 10 may be formed, for example, from polyamide, in particular polyamide 6 or polyamide 6.6.

With a small diameter of the incircle 14 and comparatively large inner diameter of the guide tube 4, it may be advantageous if the bearing 10 has at least one additional stiffening structure. FIGS. 6 and 7 schematically illustrate possible configurations of stiffening structures which are configured as stiffening elements 21. Here, both the configuration of the bearing tube 12 and the illustration of the support elements 20 (FIG. 6) is merely shown schematically. The support elements 20 are not illustrated in FIG. 7. The regions of the bearing 10 which are not illustrated in detail are configured in particular as described in the further embodiments.

In the embodiment according to FIG. 6, a stiffening element 21 with a circular cross section, which connects the support elements 20, is provided.

In the embodiment according to FIG. 7, instead of the circular stiffening elements 21, a stiffening element 21 with a triangular cross section is illustrated. Another configuration of the stiffening element 21 may also be provided. In the embodiment, the bearing tube 12 and the stiffening elements 21 are connected to each other via struts 33, which run in particular radially with respect to the central axis 11. Another configuration of the struts 33 may also be provided. The struts 33 may extend over part of or over the entire length c of the bearing 10. The arrangement of a plurality of struts 33, which are at a distance from each other in the longitudinal direction of the bearing 10, may also be advantageous.

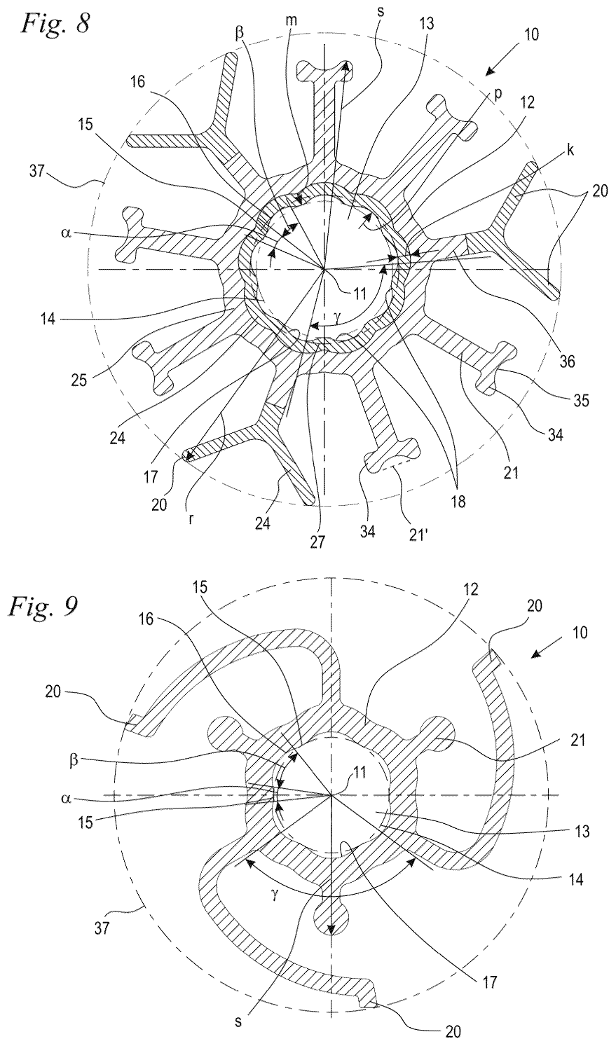

FIG. 8 shows an alternative embodiment of a bearing 10 in cross section. The bearing 10 illustrated in FIG. 8 is produced from at least two different components. A first material 24, which forms the inner wall 17 of the bearing opening 13, is provided. The first material 24 forms an approximately tubular section. A second material 25 surrounds the tubular section of the first material 24. In the embodiment, the second material 25 is a softer material than the first material 24. Stiffening elements 21 which protrude outward from the bearing tube 12, in particular approximately radially with respect to the central axis 11 are formed on the second material 25. In the embodiment, the stiffening elements 21 each bear a transverse rib 34 on the outside, thus resulting in a substantially T-shaped cross-sectional shape of the stiffening element 21. In the embodiment, the transverse rib 34 is provided with a depression 35. Alternatively, the transverse rib 34 may also be formed without a depression 35, as schematically indicated at the stiffening element 21′. The transverse rib 34 increases the rigidity of the bearing 10 even further.

In the embodiment, the support elements 20 include elastic means composed of a material differing from the second material 25, in particular from the first material 24. In the embodiment, a Y-shaped element made from the first material 24 is integrally formed on each outwardly projecting support 36 of the support element 20 made from the second material 25, the Y-shaped element forming two support points of the support element 20. Another configuration of the stiffening elements 21 and support elements 20 may also be provided. In the embodiment, six support points are provided on a total of three supports 36. This results in a support in the guide tube 4, in which the support elements 20 are not diametrically opposite with respect to the central axis 11.

In FIG. 8, the inner wall 37 of the guide tube 4 is also indicated by a dash-dotted line. The support elements 20 lie against the inner wall 37 of the guide tube 4.

The support elements 20 are at a distance r from the central axis 11. The distance r is measured to the support point of the support element 20 on the guide tube 4. The distance r is in particular the largest distance of the support element 20 from the central axis 11.

The stiffening elements 21 are at a maximum distance s from the central axis 11. In the embodiment, all of the stiffening elements 21 are at the same distance s from the central axis 11. However, different maximum distances s for the stiffening elements 21 may also be advantageous. The distance s for all of the stiffening elements 21 is smaller than the distance r of the support elements 20 from the central axis 11. Thus, when the bearing 10 is arranged in the guide tube 4, the support elements 20 are in contact with the guide tube 4, and the stiffening elements 21 are at a distance from the guide tube 4.

As FIG. 8 shows, the inner wall 17 of the bearing tube 12 is provided with first sections 15 and second sections 16, which may be formed in a manner correspondingly to the first embodiment. In the embodiment according to FIG. 8, the radii of curvature m and p are significantly smaller than in the embodiment according to FIG. 4. In the embodiment according to FIG. 8, an odd number of first sections 15 and second sections 16 is provided. As a result, the first sections 15 are not diametrically opposite with respect to the central axis 11. In the embodiment, nine first sections 15 and nine second sections 16 are provided. However, a different number of first sections 15 and second sections 16 may also be advantageous.

In the embodiment according to FIG. 8, three first sections 15 are arranged in each circumferential region y between two support elements 20 which are adjacent in the circumferential direction with respect to the central axis 11. The circumferential region y between two support elements 20 adjacent in the circumferential direction with respect to the central axis 11 is identical in size for all of the adjacent support elements 20 in the embodiment according to FIG. 8. Here, the circumferential region y is the angle measured between the connecting regions of the support elements 20 on the bearing tube 12.

In the embodiment, in each case three first sections 15 are arranged between support elements 20 which are adjacent in the circumferential direction with respect to the central axis 11. With respect to the same cross section, the drive shaft 8 is supported at more points in the bearing tube 12 than the bearing tube 12 is supported in the guide tube 4, namely nine instead of six points.

In the embodiment according to FIG. 8, the first sections 15 are in the form of elevations 18. The first sections 15 of the bearing opening 13 are convex in the embodiment according to FIG. 8.

In the embodiments, the elevations 18 are formed by indentations on the outside of the bearing tube 12 in the direction of the central axis 11. A wall thickness k of the bearing tube 12 is in particular approximately constant over the circumference of the bearing tube 12. The wall thickness k is indicated in FIG. 4 and FIG. 8. In particular, the maximum wall thickness k of the bearing tube 12 is not more than 150%, in particular not more than 120%, in particular not more than 110% of the minimum wall thickness k of the bearing tube 12.

In the embodiment according to FIG. 8, the bearing tube 12 is formed by the first material 24 with the constant wall thickness k. In an alternative embodiment, the elevations 18 may be formed as thickenings on the inner wall 17 of the bearing tube 12.

In the case of a work apparatus 1, it can be provided that the support elements 20 are elastically deformed when the bearing 10 is inserted into the guide tube 4. In a state not acted upon with a force, the support elements 20 therefore overlap with the inner wall 37 of the guide tube 4. Alternatively, an embodiment without an overlap may also be advantageous.

FIG. 9 shows a further embodiment of a bearing 10. The bearing 10 has a bearing tube 12, stiffening elements 21 and support elements 20. The bearing tube 12, the support elements 20 and the stiffening elements 21 are composed of the same material. In particular, the entire bearing 10 is composed of the same material. The bearing 10 is formed integrally. The bearing 10 is in particular formed from a single material.

The bearing 10 has six first sections 15 and six second sections 16 on the bearing tube 12.

In the embodiment, three support elements 20 and three stiffening elements 21 are provided. The support elements 20 are hook-shaped in cross section. The support elements 20 have a curved section, which in particular runs approximately spirally about the central axis 11. The support elements 20 are elastically resilient. The connecting regions of the support elements 20 are arranged in circumferential regions of the bearing tube 12, in which second sections 16 are arranged.

The stiffening elements 21 are in the form of ribs which bear a thickened portion at their end. The maximum radial distance s of the stiffening elements 21 from the central axis 11 is smaller in the embodiment according to FIG. 9 than in the embodiment according to FIG. 8. The support elements 20 extend in particular into a region which lies in the radial direction with respect to the central axis 11 between one of the stiffening elements 21 and the inner wall 37 of the guide tube 4.

In the embodiment according to FIG. 9, two first sections 15 are in each case arranged in the circumferential region y between two support elements 20 which are adjacent in the circumferential direction about the central axis 11. Here, the circumferential region y is the distance angle measured between the connecting regions of the adjacent support elements 20 on the bearing tube 12. With regard to the dimensions not described in more detail for the embodiment according to FIG. 9, reference is made here to the description of the preceding embodiments.

In all of the embodiments, the same reference signs refer to mutually corresponding elements. For elements that are not described in more detail for an embodiment, reference is made to the description of the other embodiments for the element.

In all of the embodiments, the distance a, which corresponds to the distance between the outer circle 27 and the incircle 14, is in particular less than 2 mm, in particular less than 1 mm. In particular, the distance a is from 0.2 mm to 1.0 mm, in particular approximately from 0.7 mm to 0.8 mm.

The first sections 15 in particular include all of the regions of the bearing opening 13, which are at a distance b of not more than 0.1 mm from the incircle 14.

The bearing 10 is composed in particular at least partially, in particular predominantly, in particular completely of plastic. The plastic may be, for example, a thermoplastic elastomer and/or a polyamide. It may be advantageous that a part of the bearing 10 is formed from glass fiber reinforced plastic or an overmolded metal insert.

It is understood that the foregoing description is that of the preferred embodiments of the invention and that various changes and modifications may be made thereto without departing from the spirit and scope of the invention as defined in the appended claims.

1. A bearing for mounting a drive shaft of a work apparatus in a guide tube, the bearing defining a central axis and comprising:
a bearing tube having a continuous bearing opening for receiving the drive shaft of the work apparatus;
said bearing opening defining an incircle and an inner wall and having at least one cross section whereat said bearing opening has a non-circular cross section;
in said non-circular cross section, said bearing opening having first sections lying against said incircle of said bearing opening and having second sections lying in a circumferential direction between said first sections;
said second sections lying at a distance (a) from said incircle; and,
said first sections of said bearing opening being in a form of respective elevations whereat said inner wall of said bearing opening projects in a direction of said central axis.

2. The bearing of claim 1, wherein said first sections of said bearing opening are at least partially convex.

3. The bearing of claim 1, wherein said first sections comprise all of the regions of said bearing opening that are at a distance (b) of less than 0.1 mm from the incircle.

4. The bearing of claim 1, wherein said first sections each extend over an angle of extent (α) of 1° to 20° about said central axis.

5. The bearing of claim 1, wherein said first sections each extend over an angle of extent (α) of 5° to 15° about said central axis.

6. The bearing of claim 1, wherein the first sections each extend over an angle of extent (α); and, the sum of the angles of extent (α) of all of said first sections is less than 160°.

7. The bearing of claim 1, wherein the first sections each extend over an angle of extent (α); and, the sum of the angles of extent (α) of all of the first sections is less than 120° about said central axis.

8. The bearing of claim 1, wherein the first sections each extend over an angle of extent (α); and, the sum of the angles of extent (α) of all of the first sections is not more than 90° about said central axis.

9. The bearing of claim 1, wherein said second sections of said bearing opening are at a distance (a) from said incircle of less than 2.0 mm at each position.

10. The bearing of claim 1, wherein said bearing opening has more than three first sections.

11. The bearing of claim 1, wherein said bearing opening has more than five first sections.

12. The bearing of claim 1, wherein said bearing has at least one support element extending outwardly from said bearing tube relative to said central axis.

13. The bearing of claim 12, wherein said bearing has at least two of said support elements which are adjacent and wherein at least two of said first sections are arranged in a circumferential section between said two adjacent support elements.

14. The bearing of claim 7, wherein said bearing has at least one stiffening element.

15. The bearing of claim 14, wherein said bearing has two support elements extending outwardly from said bearing tube relative to said central axis; and, said stiffening element is arranged in the circumferential direction about said central axis between said two support elements.

16. The bearing of claim 14, wherein said stiffening element extends outward radially starting from said bearing tube.

17. The bearing of claim 14, wherein said bearing has two adjacent support elements extending outwardly from said bearing tube relative to said central axis; and, said stiffening element connects said adjacent support elements in the circumferential direction about said central axis.

18. The bearing of claim 12, wherein at least one stiffening element is at a lesser maximum radial distance(s) from said central axis than the at least one support element.

19. A work apparatus comprising:
a housing;
a drive motor having an output shaft and being arranged in said housing;
a tool head having a tool;
a guide tube extending between said housing and said tool head;
a bearing arranged in said guide tube;
a drive shaft extending through said bearing and being configured to provide an operative connection between said output shaft of said drive motor and said tool of said tool head;
a bearing mounting said drive shaft in said guide tube;
said bearing defining a central axis and including:
a bearing tube having a continuous bearing opening for receiving said drive shaft of the work apparatus;
said bearing opening defining an incircle and an inner wall and having at least one cross section whereat said bearing opening has a non-circular cross section;
in said non-circular cross section, said bearing opening having first sections lying against said incircle of said bearing opening and having second sections lying in a circumferential direction between said first sections;
said second sections lying at a distance (α) from said incircle; and,
said first sections of said bearing opening being in a form of respective elevations whereat said inner wall of said bearing opening projects in a direction of said central axis.
